(19) United States
(12) Patent Application Publication
(10) Pub. No.: US 2026/0206783 A1
(43) Pub. Date: Jul. 23, 2026

(54) FOOD POWDER WITH IMPROVED STABILITY AND METHOD FOR MAKING THE SAME

(71) Applicant: SOCIÉTÉ DES PRODUITS NESTLÉ S.A., Vevey (CH)

(72) Inventors: Linda BRÜTSCH, Lausanne (CH); Vincent Daniel Maurice MEUNIER, Epalinges (CH); Reinhard BEHRINGER, Lausanne (CH)

(21) Appl. No.: 19/140,909

(22) PCT Filed: Dec. 21, 2023
(86) PCT No.: PCT/EP2023/087299

§ 371 Date: Jun. 18, 2025

(30) Foreign Application Priority Data
Dec. 22, 2022 (EP) 22215739.8

(51) Int. Cl. A23C 9/18; A23C 1/05; A23C 1/16; A23C 9/142; A23C 9/156; A23C 9/158

(52) U.S. Cl. CPC A23C 9/18; A23C 1/05; A23C 1/16; A23C 9/1422; A23C 9/156; A23C 9/158; A23C 2210/206

(57) ABSTRACT

The invention relates to a method for making a food powder with improved stability, in particular decreased hygro-capacity and increased hygro-stability. The method comprises the provision of a liquid food composition, the drying of the liquid food composition and the addition of crystalline mono- and/or di-saccharides to the food powder. In particular, at most 30% of the mono- and/or di-saccharides of the food powder are amorphous and the remainder of mono- and/or di-saccharides of the food powder are crystalline.

### TECHNICAL FIELD

The present invention relates generally to the field of food powder. For example, the present invention relates to a method of making a food powder with improved stability, in particular improved stability to moisture. It also relates to food powder obtained by said method.

### BACKGROUND OF THE INVENTION

Food powders, are generally stored in thermoplastic or metallic packaging to preserve their quality over the shelf-life. In particular, the packaging forms a barrier between the food powder and the external environment so that the organoleptic, functional, stability and hygienic properties of the food powder remain acceptable and safe until consumption.

For environmental considerations, there is an ongoing switch towards more sustainable packaging materials which are recyclable and/or biodegradable. An example of sustainable packaging materials option is paper. However, the sustainable packaging materials, such as paper, have generally weaker barrier properties, and are also more porous to the external environment than traditional packaging. As a result, the food powders packaged in sustainable packaging materials are more exposed to physico-chemical elements from the external environment, including moisture, that negatively affect their stability, organoleptic, functional, hygienic properties along their traditional shelf-life.

In particular, as the sustainable packaging materials are more porous to the external environment, the moisture uptake of food powders, such as milk powders, is accelerated. As a result, the quality and functional properties of the food powders may be detrimentally affected before the end of the traditional shelf-life. For example, the food powders may cake, exhibit carbohydrate recrystallisation, undergo Maillard reaction, have decreased flowability and reconstitution properties, show aroma or flavour loss, or even spoil early, before the end of the traditional shelf-life.

As alternative to sustainable packaging materials, the use of packaging-free options is also considered. For example, the selling of food powders in bulk is one of these options. However, the abovementioned challenges are accentuated in that case.

Hence, there remains a need to provide a food powder that exhibits improved stability, in particular with decreased hygro-capacity and so increased hygro-stability, along the shelf-life, even when exposed to external environment, including significant relative humidity and/or temperature. It is also desirable that the food powder maintains desirable and acceptable sensory properties and preferably also maintains desirable nutritional properties. Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide method and food powder that overcome the problems of the prior art and addresses the needs described above, or at least to provide a useful alternative.

The inventors were surprised to see that the object of the present invention could be achieved by the subject matter of the independent claims. The dependent claims further develop the idea of the present invention.

Accordingly, a first aspect of the invention proposes a method of making a food powder, said method comprising:
a. Providing a liquid food composition, wherein the liquid food composition comprises at most 20 wt % of mono- and/or di-saccharides by dry weight of liquid food composition and further comprises at least one component different from mono- and/or di-saccharides,
b. drying the liquid food composition to obtain a food powder,
c. adding crystalline mono- and/or di-saccharides to the food powder, wherein at most 30%, preferably at most 10% of the mono- and/or di-saccharides of the food powder are amorphous and the remainder of mono- and/or di-saccharides of the food powder are crystalline.

A second aspect of the invention proposes a food powder which comprises at least one component different from mono- and disaccharides and which further comprises mono- and/or di-saccharides, wherein at most 25 wt % of the mono- and/or di-saccharides of the food powder are amorphous and the remainder of the mono- and/or di-saccharides of the food powder are crystalline.

A third aspect of the invention proposes a food powder which comprises a food powder which is obtained by a method according to the first aspect of the invention.

It has been discovered that reformulation or treatment of food powder to limit the quantity of amorphous mono- and/or di-saccharides of the liquid food composition before drying and addition of the desired amount of mono- and/or di-saccharides in crystalline form after drying allows to improve stability of food powders along the shelf-life. In particular, this allows to decrease the hygro-capacity and so increase the hygro-stability of food powders along the shelf-life, even when exposed to external environment, including significant relative humidity and/or temperature. The food powder of the invention maintains good stability, quality, sensory and functional properties along the shelf-life. The food powder of the invention may also maintain desirable nutritional properties.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows glass transition temperature (T_{g}) as a function of the moisture content (hygro-sensitivity curve) for the different milk powders: reference whole milk powder of example 1, modular whole milk powder of example 2, reference fat-filled milk powder of example 3, modular fat-filled milk powder of example 4 and modular fat-filled milk powder with ultrafiltered fresh milk of example 5. Only the refence whole milk powder and the reference fat-filled milk powder exhibit a glass transition temperature. For the other modular milk powders of examples 2, 4 and 5, no glass transition temperature could be determined due to the negligible amount (equivalent to absence) of amorphous ingredients. Hence, no curves (called hygro-sensitivity curve) appear in FIG. 1 for the different modular milk powders of examples 2, 4 and 5 as no glass transition temperature could be determined.

FIG. 2 shows moisture content as a function of the water activity (hygro-capacity curve) for the different milk powders: reference whole milk powder of example 1, modular whole milk powder of example 2, reference fat-filled milk powder of example 3, modular fat-filled milk powder of example 4 and modular fat-filled milk powder with ultrafiltered fresh milk of example 5. Replacing amorphous lactose by crystalline lactose as shown when comparing reference milk powders to the corresponding modular milk powders results in a decrease in hygro-capacity and hence increase in stability of the milk powder.

FIG. 3 shows the moisture sorption kinetics at 25° C., i.e. moisture content over time, of the reference fat-filled milk powder and the modular fat-filled milk powder. The samples were equilibrated at a relative humidity (RH) of 20% for 100 h and then the humidity was increased by steps of 5% every 24 h from 20% to 70% RH. The reference fat-filled milk powder demonstrated from the beginning a higher moisture content and faster moisture sorption kinetics compared to the modular fat-filled milk powder. The modular fat-filled milk powder shows a lower moisture content at equivalent relative humidity, slower moisture sorption kinetics due to the lactose in the crystalline state. Moving the amorphous lactose to the crystalline state allows to increase the robustness towards humidity.

FIG. 4 shows the moisture sorption kinetics at 25° C., i.e. moisture content over time, of the reference and modular whole milk powder samples containing different amounts of crystalline/amorphous lactose (cf. example 9).

The sample “Milk no lactose in WM” corresponds to the modular whole milk powder prepared without lactose in the wet mix. In other words, the modular whole milk powder does not comprise amorphous lactose and comprises only crystalline lactose as lactose.

The samples “Milk 10% lactose in WM”, “Milk 20% lactose in WM” and “Milk 30% lactose in WM”, correspond to the modular whole milk powders prepared with respectively about 10, 20 or 30 wt % amorphous lactose in the wet mix in dry basis. In other words, the modular whole milk powders comprise respectively about 10, 20 or 30 wt % db of amorphous lactose and the remainder of the lactose being crystalline lactose.

The sample “whole milk ref” corresponds to the reference whole milk powder of example 1 wherein almost all the lactose is in the amorphous state. It comprises 39.4 wt % db of amorphous lactose.

The samples were equilibrated at a relative humidity (RH) of 20% for 100 h and then the humidity was increased by steps of 5% every 24 h from 20% to 70% RH. The higher the amount of amorphous lactose is, the higher the moisture content is at equivalent relative humidity and the faster the moisture sorption kinetics is. Moreover, the samples with higher amounts of amorphous lactose (i.e. samples with about 20% db, about 30 wt % db and with 39.4% db amorphous lactose) demonstrated a recrystallisation peak (illustrated by stars) at 55, 60 and 65% relative humidity for the whole milk ref, milk 30% lactose in WM, milk 20% lactose in WM respectively. Moving the amorphous lactose to the crystalline state allows to increase the robustness towards humidity. Nevertheless, a limited amount of lactose (milk 10% lactose in WM) is tolerated in the amorphous state without considerably impacting the quality and stability of the product.

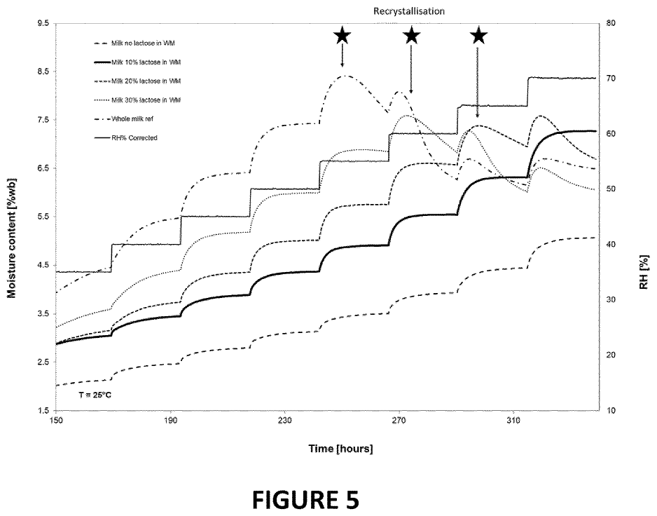

FIG. 5 shows zoom into the moisture sorption kinetics of the different milk powder samples illustrated in FIG. 4 to better highlight the differences. Increasing amount of amorphous lactose results in considerably higher moisture contents at equivalent relative humidity. Moreover, samples with large amounts of amorphous lactose (about 20-39.4% db amorphous lactose) recrystallise (illustrated by stars) when moving to high moisture contents.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

All numerical ranges should be understood to include each whole integer within the range.

As used in the specification, the singular forms “a”, “an”, and “the” include plural referents unless the context clearly dictates otherwise.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

As used herein, the term “dairy-based food powder” refers to a powder that comprises one or more dairy ingredients. Preferably, a dairy-based food powder comprises at least 5%, more preferably at least 15%, even more preferably at least 50% of dairy ingredients by dry weight.

As used herein, the term “hybrid dairy-based food powder” refers to a powder that comprises one or more dairy ingredients and one or more plant ingredients. In particular, it is a powder that comprises milk proteins and plant proteins. Preferably, at least 3%, preferably 3-50%, preferably 5-30%, more preferably 10-30% of the total protein corresponds to plant proteins. The remainder of the total protein generally are milk proteins. A hybrid dairy-based food powder has qualities as to appearance, and texture as the corresponding real dairy-based food powder.

As used herein, the term “plant-based analogue of a dairy-based food powder” refers to a food product which comprises ingredients of plant origin, which is free from dairy and which has qualities as to appearance, and texture as the corresponding real dairy-based food powder. Preferably, the dairy analogue product is exclusively made from vegan ingredients. As used herein, the term “crystalline mono- and/or di-saccharides” refers to mono- and/or di-saccharides which is characterised by having a three-dimensional long-range order of atomic positions. The atoms of crystals are arranged in a translationally periodic array.

Crystalline solids are characterised by having one melting point, at which the transition between solid and liquid state occurs (compared to T_{g} for amorphous solids). They dissolve once a critical relative humidity is reached, e.g. 83-85% for sucrose. Below this value, only negligible quantities of water can be found in crystals (stored as crystal water in the crystalline matrix).

As used herein, the term “amorphous mono- and/or di-saccharides” or “non-crystalline mono- and/or di-saccharides” refers to mono- and/or di-saccharides that possess a non-periodic array with highly-disordered atomic position. In other words, amorphous mono- and/or di-saccharides are mono- and/or di-saccharides which are a crystalline mono- and/or di-saccharides. The amorphous mono- and/or di-saccharides may be glassy or rubbery solids.

As used herein, the term “vegetarian” refers to an edible composition which is devoid of meat, including fish.

As used herein, the term “vegan” refers to an edible composition which is entirely devoid of animal products, or animal derived products.

As used herein, the term “texturizing agent” refers to ingredients other than plant proteins or dairy proteins that contribute to viscosity. Examples include starches (e.g., tapioca starch, corn starch, rice starch, potato starch, cassava starch, corn flour, and the like), pectins, gums (e.g., locust bean gum, carob bean gum, guar gum, and the like), hydrocolloids (e.g., alginate, agar, and the like), fibres.

As used herein, the term “shelf-life of x months” refers to a food powder that preserves substantially its quality and functional properties over x months (e.g. no spoilage, limited or no maillard reaction, limited or no caking, limited or no carbohydrate recrystallisation, maintain good flowability and reconstitution properties, limited or no aroma or flavor loss).

In a first aspect, the invention relates to a method of making a food powder.

In a preferred embodiment, the food powder is a hybrid dairy-based food powder, dairy-based food powder or a plant-based analogue thereof. The hybrid dairy-based food powder may be hybrid milk powder, hybrid creamer powder, hybrid yogurt powder or a hybrid dairy dessert powder. The dairy-based food powder or a plant-based analogue thereof may be milk powder, creamer powder, yogurt powder, dairy dessert powder or a plant-based analogue thereof. Preferably, the food powder may be a hybrid milk powder, milk powder or a plant-based analogue thereof. More preferably, the food powder is a milk powder or a plant-based analogue thereof.

In a more preferred embodiment, the food powder is a dairy-based food powder. The dairy-based food powder may be milk powder, creamer powder, yogurt powder, or a dairy dessert powder. Most preferably, the food powder is a milk powder.

The method comprises a step a) of providing a liquid food composition.

The liquid food composition comprises at most 20 wt % of mono- and/or di-saccharides by dry weight of the liquid food composition. Preferably, the liquid food composition comprises at most 15 wt % of mono- and/or di-saccharides by dry weight of the liquid food composition. More preferably, the liquid food composition comprises at most 10 wt % of mono- and/or di-saccharides by dry weight of the liquid food composition. Even more preferably, the liquid food composition comprises at most 5 wt % of mono- and/or di-saccharides by dry weight of the liquid food composition. Even more preferably, the liquid food composition comprises at most 1 wt % of mono- and/or di-saccharides by dry weight of the liquid food composition. Even more preferably, the liquid food composition comprises at most 0.5 wt % of mono- and/or di-saccharides by dry weight of the liquid food composition. Even more preferably, the liquid food composition comprises at most 0.1 wt % of mono- and/or di-saccharides by dry weight of the liquid food composition. Most preferably, the liquid food composition is free from mono- and di-saccharides.

In an embodiment, the liquid food composition is free from carbohydrates.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the mono- and/or di-saccharides of the liquid food composition may consist only of di-saccharides, in particular lactose. In other words, the liquid food composition may be free from monosaccharides.

It is key that the mono- and di-saccharides in the liquid food composition are limited or even absent before drying. Indeed, a major part (if not all) of the mono- and di-saccharides in solution in the liquid food composition would tend to form amorphous mono- and di-saccharides upon drying. Amorphous mono- and di-saccharides are highly hygroscopic. This results in important moisture uptake in the food powder. This decreases the stability of the powder (inc. decrease of hygro-stability and increase of hygro-capacity) and leads to the degradation of the quality and functional properties of the powder. For example, Maillard reaction, aroma or flavour loss, decrease of flowability and reconstitution properties, caking or early spoilage may happen over the shelf-life when the moisture uptake is important. Hence, an important moisture uptake may result in a powder which has undesirable properties. This limited amount of mono- and di-saccharides in the liquid food composition allows to limit or prevent the formation of amorphous mono- and di-saccharides and so maintain good properties and stability in the food powder.

The liquid food composition further comprises at least one component different from mono- and di-saccharides. Preferably, the at least one component different from mono- and di-saccharides of the liquid food composition is selected from the list consisting of proteins, fat, emulsifier, salts or a mixture thereof.

In an embodiment, the proteins of the liquid food composition consist of dairy proteins, plant proteins or a mixture thereof. In a preferred embodiment, the proteins of the liquid food composition consist only of dairy proteins.

In an embodiment, the food powder may be a plant-based analogue of a dairy-based food powder and the proteins of the liquid food composition may consist only of plant proteins. In this embodiment, the proteins may consist only of plant proteins.

In an embodiment, the food powder may be a dairy-based food powder and the proteins of the liquid food composition may consist only of milk proteins. In this embodiment, the proteins may consist only of milk proteins.

In an embodiment, the food powder may be a hybrid dairy-based food powder and the proteins of the liquid food composition may consist only of a mixture of plant proteins and milk proteins. In this embodiment, the proteins may consist only of a mixture of plant proteins and milk proteins.

In an embodiment, the fat is selected from the list consisting of vegetable fat, milk fat or a mixture thereof. The vegetable fat may be any food-grade fat which is originated from plant. Examples of vegetable fat include cocoa butter, shea butter, sunflower seed oil, palm fat, palm oil, palm olein, rapeseed oil, coconut oil, walnut oil, peanut oil, sesame oil, grape seed oil or a mixture thereof. The milk fat may be any food-grade fat which is originated from milk. In a preferred embodiment, the vegetable fat is palm fat. In another preferred embodiment, the milk fat is butter such as milk fat anhydrous. In an embodiment, the fat is a combination of palm fat and milk fat, in particular milk fat anhydrous.

In some embodiment, the fat comprises fat globules. In some embodiment, the milk fat comprises milk fat globules.

The emulsifier may be any food-grade emulsifier. Examples of emulsifier include lecithin, mono- and di-glycerides of fatty acids, sodium stearoyl lactylate (SSL), diacetyltartaric and fatty acid esters of glycerol, polyglycerol polyricinoleate (PGPR) or a mixture thereof. Preferably, the emulsifier is lecithin.

The salt may be any food-grade salts. Examples of salts include sodium salt, calcium salt, dicalcium salt, potassium salts or a mixture thereof. In a preferred embodiment, the salts are selected from the list consisting of sodium salts, calcium salts, dicalcium salts or a mixture thereof.

In an embodiment, the liquid food composition comprises fat and proteins. The fat may be fat as provided herein. The proteins may be proteins as provided herein.

In an embodiment, the liquid food composition may further comprise at least one additional ingredient. This at least one additional ingredient is different from mono- and di-saccharides, proteins, fat, emulsifier and salts. The at least one additional ingredient may be selected from the list consisting of minerals different from salts, vitamins, prebiotics, probiotics, texturizing agent, colors, flavouring agent, sweetening agent different from mono- and di-saccharides, or a mixture thereof.

It is key that the sum of mono- and di-saccharides in all the ingredients (i.e. component different from mono- and di-saccharides, additional ingredient etc.) of the liquid food composition is limited, preferably equal to zero. As mentioned above, this limits or avoids the formation of amorphous mono- and di-saccharides which are highly hygroscopic and may decrease the stability, in particular decrease hygro-stability and increase hygro-capacity of powders over the shelf-life. Examples of negative impact of amorphous mono- and di-saccharides are provided above.

Hence, the sum of mono- and/or di-saccharides in all the ingredients of the liquid food composition (i.e. protein ingredient, aqueous liquid, fat, emulsifier, salts, additional ingredient) is less than 20 wt %, preferably less than 15 wt %, more preferably less than 10 wt %, even more preferably less than 5 wt % by dry weight of liquid food composition. Most preferably, the sum of mono- and di-saccharides in all the ingredients of the liquid food composition is of 0 wt % by dry weight of liquid food composition.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the mono- and/or di-saccharides of the all the ingredients of the liquid food composition may consist only of di-saccharides, in particular lactose. In other words, the liquid food composition may be free from monosaccharides.

### Preparation of the Liquid Food Composition—Method 1

In an embodiment, the liquid food composition of step a) may be made by a method which comprises the step of dispersing at least one protein ingredient, and optionally salt into an aqueous liquid to form a liquid food composition. For example, the dispersion may be performed at 50-65° C., preferably at 60° C.

Preferably, the protein ingredient is a protein isolate or protein concentrate. Indeed, the protein isolate or concentrate has limited amount of carbohydrates, in particular mono and di-saccharides. This limits the addition of mono and di-saccharides that would form amorphous mono and di-saccharides upon drying. In a preferred embodiment, the milk protein ingredient comprises at most 5 wt. % mono and/or di-saccharides, preferably at most 1 wt % mono and/or di-saccharides, more preferably at most 0.5 wt. % mono- and/or di-saccharides, even more preferably at most 0.1 wt. % mono and/or di-saccharides, most preferably is free from mono- and di-saccharides.

The proteins of the protein ingredient consist of plant proteins, dairy proteins or a mixture thereof. In a preferred embodiment, the protein ingredient is selected from the list consisting of milk protein concentrate, whey protein isolate, micellar casein isolate, plant protein isolate, plant protein concentrate or a mixture thereof.

In an embodiment, the proteins of the protein ingredient may consist only of plant proteins. In an alternative embodiment, the proteins of the protein ingredient may consist only of dairy proteins. In an alternative embodiment, the proteins of the protein ingredient may consist only of a mixture of dairy proteins and plant proteins.

In a preferred embodiment, the proteins of the protein ingredient consist only of dairy proteins. In particular, the protein ingredient is selected from the list consisting of whey protein isolate, micellar casein isolate, milk protein concentrate or a mixture thereof.

In an embodiment the salt is not optional. The salt may be a salt as provided herein.

The aqueous liquid is a liquid which comprises at least 75 wt %, preferably at least 85 wt % of water. Preferably, the aqueous liquid is free from mono- and di-saccharides. More preferably, the aqueous liquid is free from carbohydrates. In particular, the aqueous liquid is preferably water.

In an embodiment, the aqueous liquid may be mixed with at least one additional ingredient to form the liquid food composition. This at least one additional ingredient is different from mono- and di-saccharides, proteins, emulsifier and salts. The at least one additional ingredient may be selected from the list consisting of minerals different from salts, vitamins, prebiotics, probiotics, texturizing agent, colors, flavouring agent, sweetening agent different from mono- and/or di-saccharides or a mixture thereof.

In an embodiment, the method to prepare the liquid food composition may further comprise the step of optionally mixing the liquid food composition with at least one fat, and optionally at least one emulsifier. In an embodiment, this step is not optional. The fat and the emulsifier may be as provided herein. In an embodiment, the emulsifier is not optional. For example, the mixing may be performed at 50-65° C., preferably at 60° C.

In an embodiment, the at least one fat and the emulsifier (if any) may be mixed together before being mixed with the liquid food composition. In this embodiment, the at least one fat and the emulsifier (if any) may be mixed together at a temperature of 50-65° C., preferably of 60° C.

It is key that the sum of mono- and di-saccharides in all the ingredients (i.e. protein ingredient, aqueous liquid, fat, emulsifier, salts, additional ingredient etc. . . . ) of the liquid food composition is limited, preferably equal to zero. As mentioned above, this limits or avoids the formation of amorphous mono- and di-saccharides which are highly hygroscopic and may decrease the stability, in particular decrease hygro-stability and increase hygro-capacity of powders over the shelf-life. Examples of negative impact of amorphous mono- and di-saccharides are provided above.

As provided herein above, the sum of mono- and/or di-saccharides in all the ingredients of the liquid food composition is less than 20 wt %, preferably less than 15 wt %, more preferably less than 10 wt %, even more preferably less than 5 wt % by dry weight of liquid food composition. Most preferably, the sum of mono- and/or di-saccharides in all the ingredients of the liquid food composition is of 0 wt % by dry weight of liquid food composition.

As a result, the sum of mono- and/or di-saccharides in the liquid food composition is less than 20 wt %, preferably less than 15 wt %, more preferably less than 10 wt %, even more preferably less than 5 wt % by dry weight of liquid food composition. Most preferably, the sum of mono- and/or di-saccharides in the liquid food composition is of 0 wt % by dry weight of liquid food composition.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the mono- and/or di-saccharides of all the ingredients of the liquid food composition may be selected from the list consisting of galactose, lactose, glucose, fructose, sucrose, maltose, ribose, lactulose, trehalose or a mixture thereof. Preferably, the mono- and/or di-saccharides of all the ingredients of the liquid food composition may be selected from the list consisting of lactose, galactose, glucose, sucrose, maltose, fructose or a mixture thereof. More preferably, the mono- and/or di-saccharides of all the ingredients of the liquid food composition may be selected from the list consisting of lactose, sucrose, maltose or a mixture thereof.

In an embodiment, the mono- and/or di-saccharides of all the ingredients of the liquid food composition may consist only of di-saccharides, in particular may consist only of lactose. In other words, the liquid food composition may be free from monosaccharides.

In an embodiment, the mono- and/or di-saccharides of the liquid food composition may be selected from the list consisting of galactose, lactose, glucose, fructose, sucrose, maltose, ribose, lactulose, trehalose or a mixture thereof. Preferably, the mono- and/or di-saccharides of the liquid food composition may be selected from the list consisting of lactose, galactose, glucose, sucrose, maltose, fructose or a mixture thereof. More preferably, the mono- and/or di-saccharides of the liquid food composition may be selected from the list consisting of lactose, sucrose, maltose or a mixture thereof.

In an embodiment, the mono- and/or di-saccharides of the liquid food composition may consist only of di-saccharides, in particular may consist only of lactose. In other words, the liquid food composition may be free from monosaccharides.

The method to prepare the liquid food composition may further comprise an optional step of heat-treating the liquid food composition. In an embodiment the heat treatment step is not optional.

The heat-treatment step may be performed at a temperature of at least 60° C., preferably at least 70° C., more preferably 70 to 140° C. Preferably, the heat-treatment is performed for 0.5 seconds to 30 minutes, preferably 3 seconds to 10 minutes.

The method may further comprise an optional step of homogenizing the liquid food composition. In an embodiment the homogenization step is not optional.

The homogenization step may be performed at a pressure above 50 bar. Preferably, the homogenizing step may be performed at a pressure of 50 bar to 700 bar. Further preferably, the homogenizing step may be performed at a pressure of 50 bar to 500 bar. More preferably, the homogenizing step may be performed at a pressure of 50 to 400 bar, from 100 to 400 bar or from 140 to 400 bar.

In a preferred embodiment, the homogenization step may be performed at a temperature from 50° C. to 70° C. More preferably, the step may be performed at a temperature from 55° C. to 65° C.

The step of homogenizing the food composition may be performed after or before the heat treatment step. Preferably, the step of homogenizing the food composition is performed before the heat treatment step.

### Preparation of the Liquid Food Composition—Method 2

In an alternative embodiment, the liquid food composition of step a) may be made by a method comprising the step of providing a liquid food composition comprising mono- and/or di-saccharides. For example, the liquid food composition comprising mono- and/or di-saccharides may be milk, milk concentrate reconstituted in water, milk powder reconstituted in water, juice, coffee, plant-based milk analogue or mixture thereof. The milk may be skimmed milk, semi-skimmed milk, whole milk, or a mixture thereof. Preferably, the liquid food composition comprising mono- and/or di-saccharides is milk.

In an embodiment, the proteins of the liquid food composition may consist of plant proteins, dairy proteins or a mixture thereof. In an embodiment, the proteins of the liquid food composition may consist only of plant proteins. In an alternative embodiment, the proteins of the liquid food composition may consist only of dairy proteins. In an alternative embodiment, the proteins of the liquid food composition may consist only of a mixture of dairy proteins and plant proteins.

In a preferred embodiment, the proteins of the liquid food composition consist only of dairy proteins.

In an embodiment, the mono- and/or di-saccharides content in the liquid food composition before removal step is higher than 80 wt %, 70 wt %, 60 wt %, 50 wt %, 40 wt. %, 30 wt. %, 20 wt %, 15 wt %, 10 wt %, 5 wt % or 1 wt % by dry weight of the liquid food composition. In an embodiment, the mono- and/or di-saccharides content in the liquid food composition before removal step is higher than 1 wt. %, preferably higher than 5 wt. %, more preferably higher than 10 wt %, even more preferably higher than 15 wt %, even more preferably higher than 20 wt %, even more preferably higher than 40 wt %, even most preferably higher than 50 wt % by dry weight of the liquid food composition.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the mono- and/or di-saccharides of the liquid food composition may be selected from the list consisting of galactose, lactose, glucose, fructose, sucrose, maltose, ribose, lactulose, trehalose or a mixture thereof. Preferably, the mono- and/or di-saccharides of the liquid food composition may be selected from the list consisting of lactose, galactose, glucose, sucrose, maltose, fructose or a mixture thereof. More preferably, the mono- and/or di-saccharides of the liquid food composition may be selected from the list consisting of lactose, sucrose, maltose or a mixture thereof.

In an embodiment, the mono- and/or di-saccharides of the liquid food composition may consist only of di-saccharides, in particular may consist only of lactose. In other words, the liquid food composition may be free from monosaccharides.

The method to prepare the liquid food composition further comprises a step of removing part or all mono- and/or di-saccharides of the liquid food composition. The removal step is preferably performed by filtration. The filtration may be performed by dead-end filtration, microfiltration, nanofiltration and/or ultrafiltration. More preferably, the filtration is performed by ultrafiltration or nanofiltration. As a result, after the removal step, the liquid food composition comprises at most 20 wt %, preferably at most 15 wt %, more preferably at most 10 wt %, even more preferably at most 5 wt %, even more preferably at most 1 wt. %, even more preferably at most 0.5 wt. %, even more preferably at most 0.1 wt. % of mono- and/or di-saccharides by dry weight of the liquid food composition. Most preferably, after filtration step, the liquid food composition is free from mono- and di-saccharides. After filtration, the liquid food composition may be free from carbohydrates.

This removal step of mono- and di-saccharides limits or avoids the formation upon drying of amorphous mono- and di-saccharides which are highly hygroscopic and may decrease the stability, in particular hygro-stability and increase hygro-capacity of powders over the shelf-life. Examples of negative impact of amorphous mono- and di-saccharides are provided above.

In an embodiment, after filtration, the liquid food composition may be mixed with proteins, fat, emulsifier, salts, minerals different from salts, vitamins, prebiotics, probiotics, texturizing agent, colors, flavouring agent, sweetening agent different from mono- and di-saccharides or a mixture thereof. The proteins, fat, emulsifier and salt may be as provided above.

It is key that the sum of mono- and di-saccharides in all the ingredients (i.e. protein ingredient, aqueous liquid, fat, emulsifier, salts, additional ingredient etc. . . . ) of the liquid food composition is limited, preferably equal to zero. As mentioned above, this limits or avoids the formation of amorphous mono- and di-saccharides which are highly hygroscopic and may decrease the stability, in particular decrease hygro-stability and increase hygro-capacity of powders over the shelf-life. Examples of negative impact of amorphous mono- and di-saccharides are provided above.

As provided herein above, the sum of mono- and/or di-saccharides in all the ingredients of the liquid food composition is less than 20 wt %, preferably less than 15 wt %, more preferably less than 10 wt %, even more preferably less than 5 wt % by dry weight of liquid food composition. Most preferably, the sum of mono- and di-saccharides in all the ingredients of the liquid food composition is of 0 wt % by dry weight of liquid food composition.

As a result, the sum of mono- and/or di-saccharides in the liquid food composition is less than 20 wt %, preferably less than 15 wt %, more preferably less than 10 wt %, even more preferably less than 5 wt %, most preferably is of 0 wt % by dry weight of liquid food composition.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the mono- and/or di-saccharides of all the ingredients of the liquid food composition may be selected from the list consisting of galactose, lactose, glucose, fructose, sucrose, maltose, ribose, lactulose, trehalose or a mixture thereof. Preferably, the mono- and/or di-saccharides of all the ingredients of the liquid food composition may be selected from the list consisting of lactose, galactose, glucose, sucrose, maltose, fructose or a mixture thereof. More preferably, the mono- and/or di-saccharides of all the ingredients of the liquid food composition may be selected from the list consisting of lactose, sucrose, maltose or a mixture thereof.

In an embodiment, the mono- and/or di-saccharides of all the ingredients of the liquid food composition may consist only of di-saccharides, in particular may consist only of lactose. In other words, the liquid food composition may be free from monosaccharides.

In an embodiment, the mono- and/or di-saccharides of the liquid food composition may be selected from the list consisting of galactose, lactose, glucose, fructose, sucrose, maltose, ribose, lactulose, trehalose or a mixture thereof. Preferably, the mono- and/or di-saccharides of the liquid food composition may be selected from the list consisting of lactose, galactose, glucose, sucrose, maltose, fructose or a mixture thereof. More preferably, the mono- and/or di-saccharides of the liquid food composition may be selected from the list consisting of lactose, sucrose, maltose or a mixture thereof.

In an embodiment, the mono- and/or di-saccharides of the liquid food composition may consist only of di-saccharides, in particular may consist only of lactose. In other words, the liquid food composition may be free from monosaccharides.

The method to prepare the liquid food composition may further comprise an optional step of heat-treating the liquid food composition. In an embodiment the heat treatment step is not optional.

The heat-treatment step may be performed at a temperature of at least 60° C., preferably at least 70° C., more preferably 70 to 140° C. Preferably, the heat-treatment is performed for 0.5 seconds to 30 minutes, preferably 3 seconds to 10 minutes.

The method to prepare the liquid food composition may further comprise an optional step of homogenizing the liquid food composition. In an embodiment the homogenization step is not optional.

The homogenization step may be performed at a pressure above 50 bar. Preferably, the homogenizing step may be performed at a pressure of 50 bar to 700 bar. Further preferably, the homogenizing step may be performed at a pressure of 50 bar to 500 bar. More preferably, the homogenizing step may be performed at a pressure of 50 to 400 bar, from 100 to 400 bar or from 140 to 400 bar.

In a preferred embodiment, the homogenization step may be performed at a temperature from 50° C. to 70° C. More preferably, the step may be performed at a temperature from 55° C. to 65° C.

The homogenization step may be after or before the heat treatment step. Preferably, the homogenization step is before the heat treatment step.

The method of the invention further comprises a step b) of drying the liquid food composition to obtain a food powder. The drying step is made by way of a dryer, also called drying equipment. The step of drying may be performed by any drying technologies well known in the art suitable for food products. For example, the drying step may be performed by drum drying, roller drying, spray drying or freeze drying.

In some embodiment, the drying step is performed with a drying technology different from roller drying and/or freeze drying. The disadvantages of roller drying and freeze drying are provided in the second aspect of the invention.

Preferably, the drying step is performed by spray drying. The advantage of spray drying is provided in the second aspect of the invention. The method of the invention further comprises a step c) of adding crystalline mono- and/or di-saccharides to the food powder. In step c) the crystalline mono- and/or di-saccharides are added in dry to the food powder. In a preferred embodiment, the crystalline mono- and/or di-saccharides are added in step c) by dry mixing or by fluid bed agglomeration.

In another preferred embodiment, the step c) of addition of crystalline mono- and/or di-saccharides and the step b) of drying are simultaneous, and the crystalline mono- and/or di-saccharides are directly added into the dryer while the liquid food composition is dried in the dryer.

After crystalline mono- and/or di-saccharides addition, at most 30%, preferably at most 25%, more preferably at most 15%, even more preferably at most 10%, even more preferably at most 5%, even more preferably at most 1%, even more preferably at most 0.5%, even more preferably at most 0.1% of the mono- and/or di-saccharides of the food powder are amorphous and the remainder of the mono and/or di-saccharides of the food powder are crystalline.

In a most preferred embodiment, the food powder is free from amorphous mono- and/or di-saccharides. In other words, the mono- and/or di-saccharides of the food powder consist only of crystalline mono- and/or di-saccharides.

In an embodiment, the food powder comprises less than 10 wt % sucrose, preferably less than 8 wt. % sucrose, more preferably less than 6 wt. % sucrose by dry weight of the food powder. In another embodiment, the food powder is free from sucrose. The presence of sucrose is preferably limited or avoided due to its hygroscopic and/or caloric properties.

In an embodiment, the crystalline mono- and/or di-saccharides of the food powder are not embedded in the amorphous matrix of the food powder. In particular, the crystalline mono- and/or di-saccharides of the food powder may be in free form or adsorbed to the amorphous matrix of the food powder. The amorphous matrix of the food powder corresponds generally to the matrix obtained upon the drying of the component (e.g. fat, protein, emulsifier, etc.) of the liquid food composition in step b). The amorphous matrix excludes the crystalline mono- and/or di-saccharides, in particular the crystalline mono- and/or di-saccharides that are added in step c).

In an embodiment, after addition of crystalline mono- and/or di-saccharides in step c), the total mono and/or di-saccharides content of the food powder is of 10 to 80 wt. %, preferably 10 to 70 wt. %, more preferably 10 to 60 wt. %, even more preferably 20 to 60 wt. %, most preferably 20 wt. % to 50 wt. % by dry weight.

The addition of crystalline mono- and/or di-saccharides after drying allows to reduce the hygro-capacity and increase the hygro-stability of the food powder without impacting the sensory properties but also the nutritional properties. Indeed, the invention relies on the change of state of the mono- and/or disaccharides, from the amorphous to the crystalline state while the amount of mono- and/or di-saccharides may be maintained such that the sensory and optionally, nutritional properties of the food powder are not affected. In other words, the amount of mono- and/or di-saccharides may be maintained in the food powder of the invention at the same level as the corresponding targeted reference food powder such that the sensory properties and optionally, nutritional properties are equivalent to the targeted reference food powder. For example, the invention allows to achieve a milk powder that has the same level of lactose than a standard milk powder but wherein the lactose is mostly in the crystalline state compared to a standard milk powder wherein the lactose is in the amorphous state.

Examples of crystalline mono-saccharides include crystalline galactose, crystalline glucose, crystalline fructose, crystalline ribose or a mixture thereof.

Examples of crystalline di-saccharides include crystalline lactose, crystalline sucrose, crystalline maltose, crystalline lactulose, crystalline trehalose or a mixture thereof.

In other words, examples of crystalline mono- and di-saccharides include crystalline galactose, crystalline lactose, crystalline glucose, crystalline fructose, crystalline sucrose, crystalline maltose, crystalline ribose, crystalline lactulose, crystalline trehalose or a mixture thereof.

In an embodiment, the crystalline mono- and/or di-saccharides added in step c) may be selected from the list consisting of crystalline galactose, crystalline lactose, crystalline glucose, crystalline fructose, crystalline sucrose, crystalline maltose, crystalline ribose, crystalline lactulose, crystalline trehalose or a mixture thereof. Preferably, the crystalline mono- and/or di-saccharides added in step c) may be selected from the list consisting of crystalline lactose, crystalline galactose, crystalline glucose, crystalline sucrose, crystalline maltose, crystalline fructose or a mixture thereof. More preferably, the crystalline mono- and/or di-saccharides added in step c) may be selected from the list consisting of crystalline lactose, crystalline sucrose, crystalline maltose or a mixture thereof.

In an embodiment, at least 50%, preferably at least 60%, more preferably at least 70%, even more preferably at least 80%, even more preferably at least 90% of the crystalline mono and/or di-saccharides saccharides added in step c) may consist of crystalline di-saccharides, in particular may consist of crystalline lactose. In a most preferred embodiment, the crystalline mono- and/or di-saccharides added in step c) may consist only of crystalline di-saccharides, in particular may consist only of crystalline lactose. In other words, no crystalline monosaccharides may be added in step c).

In an embodiment, the mono- and/or di-saccharides of the food powder may be selected from the list consisting of galactose, lactose, glucose, fructose, sucrose, maltose, ribose, lactulose, trehalose or a mixture thereof. Preferably, the mono- and/or di-saccharides of the food powder may be selected from the list consisting of lactose, galactose, glucose, sucrose, maltose, fructose or a mixture thereof. More preferably, the mono- and/or di-saccharides of the food powder may be selected from the list consisting of lactose, sucrose, maltose or a mixture thereof.

In a most preferred embodiment, the mono- and/or di-saccharides of the food powder may consist only of di-saccharides, in particular may consist only of lactose. In other words, the food powder is free from monosaccharides.

In an embodiment, at least one additional ingredient may be added during or after step c). This at least one additional ingredient is different from mono- and di-saccharides. The additional ingredient may be selected from the list consisting of fat, emulsifier, protein, salts, minerals different from salts, vitamins, prebiotics, probiotics, texturizing agent, colors, flavouring agent, sweetening agent different from mono- and di-saccharides, maltodextrin or a mixture thereof. Preferably, the at least one additional ingredient should be free from amorphous mono- and di-saccharides. The at least one additional ingredient may also comprise amorphous mono- and di-saccharides but the amount of amorphous mono- and/or di-saccharides in the at least one additional should be such that the total amount of amorphous mono- and/or di-saccharides in the food powder does not exceed the maximal amount of amorphous mono- and/or di-saccharides provided above.

It has been discovered that the use of liquid food compositions with limited or no mono- and/or di-saccharides in the manufacturing of food powders and the addition of mono- and/or di-saccharides after drying in crystalline form allows to improve the stability (i.e. improved hygro-stability and decreased hygro-capacity) of the food powders over shelf-life while maintaining desirable and acceptable organoleptic sensory. In particular, the obtained food powder may not show significant detrimental degradation of its quality and functional properties (e.g. no caking) over shelf-life, even when exposed to higher relative humidity (e.g. relative humidity at 40% or may be even higher e.g. 55%-70%). This is due that the process limits or prevents the presence of mono- and/or di-saccharides in amorphous form.

The limitation or absence of mono- and/or di-saccharides in the liquid food composition may be achieved by 1) reformulation of the liquid food composition with ingredients with limited amount or without mono- and/or di-saccharides or 2) treatment to remove the mono- and/or di-saccharides from the liquid food composition. Crystalline mono- and/or di-saccharides are added after drying. This compensates the sensory defect induced by the limitation or absence of mono- and/or di-saccharides. This also limits or prevents the formation of amorphous mono- and di-saccharides as they are added in the powder which is already dried. In addition, the crystalline mono- and/or di-saccharides are significantly less hygroscopic than the amorphous such that the stability of the food powder, in particular to moisture, is enhanced over shelf-life. The powder of the invention has desirable and acceptable sensory properties as the mono- and/or di-saccharides are maintained through addition after drying.

In a preferred embodiment, the food powder is not roller dried food powder and/or is not a freeze-dried food powder. In a more preferred embodiment, the food powder is a spray-dried food powder.

In an embodiment, the food powder comprises fat globules, in particular milk fat globules.

In an embodiment, the food powder may comprise less than 5 wt. %, preferably less than 2 wt. %, more preferably less than 1.5 wt. %, even more preferably less than 1 wt. %, even more preferably less than 0.5 wt. % free fat. In an even more preferred embodiment, the food powder is free from free fat. The free fat content of the food powder should be limited to avoid unsatisfactory reconstitution properties. Free fat may also be designated as surface fat.

In a second aspect, the invention relates to a food powder.

The food powder may be a food powder as provided in the first aspect of the invention, and vice versa.

The food powder comprises at least one component different from mono- and di-saccharides. The at least one component different from mono- and di-saccharides may be as provided in the first aspect of the invention.

The food powder further comprises mono- and/or di-saccharides, wherein at most 30%, preferably at most 25%, more preferably at most 15%, even more preferably at most 10%, even more preferably at most 5%, even more preferably at most 1%, even more preferably at most 0.5%, even more preferably at most 0.1% of the mono- and/or di-saccharides of the food powder are amorphous and the remainder of the mono and/or di-saccharides of the food powder are crystalline.

In a most preferred embodiment, the food powder is free from amorphous mono- and/or di-saccharides. In other words, the mono- and/or di-saccharides of the food powder consist only of crystalline mono- and/or di-saccharides.

Examples of monosaccharides include galactose, glucose, ribose, fructose or a mixture thereof.

Examples of di-saccharides include lactose, sucrose, maltose, lactulose, trehalose or a mixture thereof.

In other words, examples of mono- and di-saccharides include galactose, glucose, ribose, fructose, lactose, sucrose, maltose, lactulose, trehalose or a mixture thereof.

In an embodiment, the crystalline mono- and/or di-saccharides of the food powder may be selected from the list consisting of crystalline galactose, crystalline lactose, crystalline glucose, crystalline fructose, crystalline sucrose, crystalline maltose, crystalline ribose, crystalline lactulose, crystalline trehalose or a mixture thereof. Preferably, the crystalline mono- and/or di-saccharides of the food powder may be selected from the list consisting of crystalline lactose, crystalline galactose, crystalline glucose, crystalline sucrose, crystalline maltose, crystalline fructose or a mixture thereof. More preferably, the crystalline mono- and/or di-saccharides of the food powder may be selected from the list consisting of crystalline lactose, crystalline sucrose, crystalline maltose or a mixture thereof.

In an embodiment, at least 50%, preferably at least 60%, more preferably at least 70%, even more preferably at least 80%, even more preferably at least 90% of the crystalline mono and/or di-saccharides of the food powder may consist of crystalline di-saccharides, in particular consist only of crystalline lactose.

In a preferred embodiment, the crystalline mono and/or di-saccharides of the food powder may consist only of crystalline di-saccharides, in particular consist only of crystalline lactose. In other words, the food powder is free from crystalline monosaccharides.

In an embodiment, the mono- and/or di-saccharides of the food powder may be selected from the list consisting of galactose, lactose, glucose, fructose, sucrose, maltose, ribose, lactulose, trehalose or a mixture thereof. Preferably, the mono- and/or di-saccharides of the food powder may be selected from the list consisting of lactose, galactose, glucose, sucrose, maltose, fructose or a mixture thereof. More preferably, the mono- and/or di-saccharides of the food powder may be selected from the list consisting of lactose, sucrose, maltose or a mixture thereof.

In an embodiment, at least 50%, preferably at least 60%, more preferably at least 70%, even more preferably at least 80%, even more preferably at least 90% of the mono and/or di-saccharides of the food powder may consist of di-saccharides, in particular consist of crystalline lactose.

In another preferred embodiment, the mono and/or disaccharides of the food powder may consist only of di-saccharides, in particular consist only of lactose. In other words, the amorphous mono and/or disaccharides of the food powder may consist only of amorphous di-saccharides, in particular amorphous lactose and the crystalline mono and/or disaccharides of the food powder may consist only of crystalline di-saccharides, in particular crystalline lactose. In particular, the food powder may be free from monosaccharides.

In an embodiment, the food powder comprises less than 10 wt % sucrose, preferably less than 8 wt. % sucrose, more preferably less than 6 wt. % sucrose by dry weight of the food powder. In another embodiment, the food powder is free from sucrose. The presence of sucrose is preferably limited or avoided due to its hygroscopic and/or caloric properties.

In an embodiment, the crystalline mono- and/or di-saccharides of the food powder are not embedded in the amorphous matrix of the food powder. In particular, the crystalline mono- and/or di-saccharides of the food powder may be in free form or adsorbed to the amorphous matrix of the food powder.

In an embodiment, the food powder comprises 10 to 80 wt. %, preferably 10 to 70 wt. %, more preferably 10 to 60 wt. %, even more preferably 20 to 60 wt. %, most preferably 20 wt. % to 50 wt. % mono- and/or di-saccharides by dry weight. The mono- and/or di-saccharides may be mono- and/or di-saccharides as provided herein or as provided in the first aspect of the invention. In an embodiment, the food powder may comprise fat. The food powder may comprise 0 to 40 wt %, preferably 1 to 40 wt %, more preferably 10 to 40 wt %, even more preferably 20 to 40 wt % fat by dry weight. The fat may be fat as provided in the first aspect of the invention.

In an embodiment, the food powder may comprise proteins. The food powder may comprise 5 to 70 wt %, preferably 10 to 50 wt %, more preferably 20 to 50 wt %, even more preferably 20 to 40 wt % proteins by dry weight. The proteins may be proteins as provided in the first aspect of the invention.

In an embodiment, the food powder may comprise salt. The food powder may comprise 0 to 5 wt %, preferably 0.1 to 5 wt %, more preferably 0.5 to 5 wt % salt, even more preferably 1.5 to 4 wt % by dry weight. The salt may be salt as provided in the first aspect of the invention.

In an embodiment, the food powder comprises 0 to 2 wt %, preferably 0.05 to 2 wt %, more preferably 0.1 to 2 wt %, even more preferably 0.3 to 1 wt. % emulsifier by dry weight. The emulsifier may be emulsifier as provided in the first aspect of the invention.

In an embodiment, the food powder may comprise at least one additional ingredient. The at least one additional ingredient is different from mono- and di-saccharides. The additional ingredient may be selected from the list consisting of minerals different from salts, vitamins, prebiotics, probiotics, texturizing agent, colors, flavouring agent, sweetening agent different from mono- and di-saccharides, maltodextrin or a mixture thereof. Preferably, the at least one additional ingredient should be free from amorphous mono- and di-saccharides. The at least one additional ingredient may also comprise amorphous mono- and di-saccharides but the amount of amorphous mono- and/or di-saccharides in the at least one additional should be such that the total amount of amorphous mono- and/or di-saccharides in the food powder does not exceed the maximal amount of amorphous mono- and/or di-saccharides provided above.

In an embodiment, the food powder has a shelf-life of at least 3 months, preferably of 3 to 24 months, more preferably 3 to 12 months, even more preferably 9 to 12 months when stored at room temperature or at a temperature ranging from 15 to 25° C. Preferably, this shelf-life applies when the food powder is also stored at a relative humidity of 40% to 70%, preferably 55 to 70%, more preferably 60% to 70%.

In an embodiment, the food powder comprises a moisture content of less than 5 wt %. Preferably, the food powder comprises a moisture content of less than 5 wt % for at least 3 months, preferably of 3 to 24 months, more preferably 3 to 12 months, even more preferably 9 to 12 months when stored at room temperature or at a temperature ranging from 15 to 25° C. and a relative humidity of 40% to 70%, preferably 55 to 70%, more preferably 60% to 70%.

The powder of the invention has limited amount or is free from amorphous mono- and di-saccharides while having a major part or all of the mono- and di-saccharides being crystalline. As a result, the powder has improved stability over shelf-life, in particular to moisture. The powder of the invention has decreased hygro-capacity and increased hygro-stability over shelf-life. In particular, the powder of the invention is less prone to caking over shelf-life, even when exposed to important relative humidity. The powder maintains acceptable sensory properties.

In a preferred embodiment, the food powder is not roller dried food powder and/or is not a freeze-dried food powder.

Roller drying and freeze drying are not advantageous because they alter the structure of fat and increase the presence of free fat in the food powder. A substantial presence of free fat negatively impacts the reconstitution properties of the food powder. Roller drying and freeze drying are especially not advantageous when the food powder is dairy-based food powder or hybrid dairy-based food powder. Indeed, such drying treatments alter negatively the milk fat globules structures and increases substantially the presence of free fat. Moreover, roller drying is not advantageous as it develops sensory changes upon Maillard reaction (e.g. caramelized notes) that may be undesirable depending on the application (e.g. milk powder).

In a more preferred embodiment, the food powder is a spray-dried food powder. Spray drying is advantageous because it limits the generation of free fat and sensory defects due to Maillard reaction. Spray drying is especially advantageous when the food powder is dairy-based food powder or hybrid dairy-based food powder. Indeed, it limits alteration of the structure of milk fat globules and so limits the formation of free fat. In an embodiment, the food powder comprises fat globules, in particular milk fat globules.

In an embodiment, the food powder may comprise less than 5 wt. %, preferably less than 2 wt. %, more preferably less than 1.5 wt. %, even more preferably less than 1 wt. %, even more preferably less than 0.5 wt. % free fat. In an even more preferred embodiment, the food powder is free from free fat. The free fat content of the food powder should be limited to avoid unsatisfactory reconstitution properties.

In a third aspect, the invention relates to a food powder obtained by the method of the first aspect of the invention.

The features of the food powder of the second aspect of the invention may apply to the food powder of the present third aspect of the invention.

Those skilled in the art will understand that they can freely combine all features of the present invention disclosed herein. In particular, features described for the product of the present invention may be combined with the method of the present invention and vice versa. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### EXAMPLES

### Example 1: Preparation of a Reference Whole Milk Powder

A reference whole milk powder was prepared.

To do so, milk fat anhydrous, milk protein concentrate (in here, milk protein concentrate has maximum 4% lactose) and lactose were mixed with water at 60° C. to obtain a wet mix having a total solids content of 40 wt %. Then, the wet mix was homogenized at 140 bars and at 60° C., pasteurized at 83° C. for 4 seconds and then spray dried to obtain a whole milk powder consisting of milk fat anhydrous (28.3% db), milk protein concentrate (32.3% db) and lactose (39.4% db). The reference whole milk powder is rich in amorphous lactose and the lactose of the reference whole milk powder mainly consists of amorphous lactose (about 39.4% db).

### Example 2: Preparation of a Modular Whole Milk Powder with Negligible Amount of Amorphous Lactose and Sensory Tasting

A modular whole milk powder was prepared with negligible amount of amorphous lactose. In particular, it comprises a negligible amount of lactose in the wet mix before spray drying.

To do so, milk fat anhydrous and milk protein concentrate (in here, milk protein concentrate has maximum 4% lactose) were mixed at 60° C. with water to obtain a wet mix having a total solids content of 40 wt % and which comprises less than 0.1 wt. % of lactose. This negligible amount of lactose comes from milk protein concentrate. The wet mix does not comprise mono- and di-sacccharides other than lactose. Then, the wet mix was homogenized at 140 bars and at 60° C., pasteurized at 83° C. for 4 seconds and then spray dried to obtain a whole milk powder. The required amount of crystalline lactose was then dry mixed with the whole milk powder to achieve a modular whole milk powder with the same composition as the reference whole milk powder of example 1, i.e. milk fat anhydrous (28.3% db), milk protein concentrate (32.3% db) and lactose (39.4% db). The difference between the modular whole milk powder and the reference whole milk powder of example 1 is that the lactose of the modular whole milk powder of the present example mainly consists of crystalline lactose. In particular, it comprises a very minor and negligible fraction of amorphous lactose/i.e. less than 0.1 wt. % db.

10 g of the reference whole milk powder of example 1 or 10 g of the modular whole milk powder of the present example were diluted respectively in 200 ml of water and tasted by people trained to assess the sensory properties, including taste and texture of milk. The modular whole milk powder was compared to the reference whole milk powder. The modular whole milk powder retains acceptable and even equivalent sensory properties compared to the reference whole milk powder.

### Example 3: Preparation of Reference Fat-Filled Milk Powder

A reference fat-filled milk powder was prepared.

To do so, skimmed milk powder was mixed at 60° C. with fresh milk to obtain a wet mix.

In parallel, palm fat and emulsifier (lecithin) at 60° C. were mixed together to form a pre-emulsion. The pre-emulsion is free from any mono- and di-saccharides, including free from lactose.

The pre-emulsion was mixed at 60° C. to the wet mix to form a mixture having a total solids content of 40%. The mixture was then homogenized at 140 bar at 60° C., pasteurized at 83° C. for 4 seconds and then spray dried to obtain fat-filled milk powder. Additional ingredients including crystalline sucrose flavours, vitamins, minerals, maltodextrin and salts were further added in dry to the fat-filled milk powder to obtain the final reference fat-filled milk powder. The composition of the reference fat-filled milk is provided in table 1.

The reference fat-filled milk powder is rich in amorphous lactose and the lactose of the reference fat-filled milk powder mainly consists of amorphous lactose.

The sucrose and the maltose (coming from maltodextrin) of the reference fat-filled milk powder are exclusively in crystalline form as they are added after drying.

TABLE 1

| | Amount in the final |
|---|---|
| | powder |
| Ingredients | (% db) |
| Water evaporation | 0.58 |
| Crystalline sucrose | 5.77 |
| Maltodextrin | 12.90 |
| Palm fat | 6.20 |
| Lecithin | 0.32 |
| Vitamins, Minerals, Salts | 3.65 |
| Flavours | 0.47 |
| Milk fat anhydrous (coming | 14.46 |
| from the fresh milk) | |
| Milk solid non fat (coming | 12.81 |
| from the fresh milk) | |
| Skimmed milk powder | 43.42 |
| Lactose | — |
| Milk fat anhydrous | — |
| Protein concentrate | — |

### Example 4: Preparation of the Modular Fat-Filled Milk Powder with Negligible Amount of Amorphous Lactose and Sensory Tasting

A modular fat-filled milk powder was prepared with negligible amount of amorphous lactose. In particular, it comprises a negligible amount of lactose in the wet mix before spray drying.

The formulation and the process for preparing the reference fat-filled milk powder was adapted to prepare a modular fat-filled milk powder having still equivalent protein, fat and lactose composition as the reference but while limiting amorphous lactose (negligible amount) compared to the reference. In particular, the fresh milk and the skimmed milk powder were removed to limit amorphous lactose. Equivalent level of milk fat and protein that were present in the fresh milk and skimmed milk powder were added separately in the wet mix. Likewise, equivalent level of lactose was added in crystalline form after drying.

To do so, milk protein concentrate (in here, milk protein concentrate has maximum 4% lactose) was mixed at 60° C. with water to obtain a wet mix which comprises less than 0.1 wt. % of lactose. This negligible amount of lactose originates from milk protein concentrate. The wet mix does not comprise mono- and di-sacccharides other than lactose.

In parallel, milk fat anhydrous, palm fat and emulsifier (lecithin) were mixed at 60° C. to form a pre-emulsion. The pre-emulsion is free from mono- and di-saccharides, including free from lactose.

The pre-emulsion was mixed at 60° C. to the wet mix to form a mixture. The mixture was then homogenized at 140 bars and at 60° C., pasteurized at 83° C. for 4 seconds and then spray dried to obtain a modular fat-filled milk powder. Additional ingredients including flavors, vitamins, minerals, salts, crystalline lactose, maltodextrin and crystalline sucrose were further added in dry, in particular dry mixed, to the modular fat-filled milk powder to obtain the final modular filled milk powder.

The composition of the modular fat-filled milk powder is provided in table 2.

The lactose of the modular fat-filled milk powder of the present example mainly consists of crystalline lactose. In particular, it comprises a very minor and negligible fraction of amorphous lactose/i.e. less than 0.1 wt. % db.

The sucrose of the modular fat-filled milk powder of the present example is exclusively in crystalline form.

The maltose (coming from maltodextrin) of the modular fat-filled milk powder of the present example is exclusively in crystalline from.

10 g of the reference fat-filled milk powder of example 3 and 10 g modular fat-filled milk powder of the present example were diluted respectively in 100 ml of water and tasted by people trained to assess the sensory properties, including taste and texture of milk. The modular fat-filled milk powder was compared to the reference fat-filled milk powder. The modular fat-filled milk powder retains acceptable and even equivalent sensory properties compared to the reference fat-filled milk powder.

TABLE 2

| | Amount in the final |
|---|---|
| | powder |
| Ingredients | (% db) |
| Water evaporation | 0.58 |
| Crystalline sucrose | 5.77 |
| Maltodextrin | 12.90 |
| Palm fat | 6.20 |
| Lecithin | 0.32 |
| Vitamins, Minerals, Salts | 3.65 |
| Flavours | 0.47 |
| Milk fat anhydrous (coming | — |
| from fresh milk) | |
| Milk solid non fat (coming | — |
| from fresh milk) | |
| Skimmed milk powder | — |
| Crystalline lactose | 33.7 |
| Milk fat anhydrous | 14.46 |
| Protein concentrate | 22.5 |

### Example 5: Preparation of Modular Fat-Filled Milk Powder Starting from Ultrafiltered Fresh Milk which is Free from Lactose

A modular fat-filled milk powder was prepared with ultrafiltered fresh whole milk which is free from lactose.

To do so, milk protein concentrate (in here, milk protein concentrate has maximum 4% lactose) was mixed at 60° C. with ultrafiltered fresh milk which is free from lactose to obtain a wet mix which comprises less than 0.1 wt. % of in particular lactose. This negligible amount of lactose comes from the milk protein concentrate. The wet mix does not comprise mono- and di-sacccharides other than lactose.

In parallel, milk fat, palm fat and emulsifier (lecithin) were mixed together at 60° C. to form a pre-emulsion. The pre-emulsion is free from any mono- and di-saccharides, including free from lactose.

The pre-emulsion was mixed at 60° C. to the heat-treated wet mix to form a mixture. The mixture was then homogenized at 140 bars and at 60° C., pasteurized at 83° C. for 4 seconds and then spray dried to obtain modular fat-filled milk powder. Additional ingredients including flavors, vitamins, minerals, salts, crystalline lactose, maltodextrin and crystalline sucrose were further added in dry, in particular dry mixed, to the modular fat-filled milk powder to obtain the final modular filled milk powder.

The composition of the modular fat-filled milk is provided in table 3.

The lactose of the modular fat-filled milk powder with ultrafiltered fresh milk of the present example mainly consists of crystalline lactose. In particular, it comprises a very minor and negligible fraction of amorphous lactose/i.e. less than 0.1 wt. % db.

The sucrose of the modular fat-filled milk powder with ultrafiltered fresh milk of the present example is exclusively in crystalline form.

The maltose (coming from maltodextrin) of the modular fat-filled milk powder with ultrafiltered fresh milk of the present example is exclusively in crystalline from.

10 g of the reference fat-filled milk powder of example 3 and 10 g modular fat-filled milk powder with ultrafiltered fresh milk of the present example were diluted respectively in 100 ml of water and tasted by people trained to assess the sensory properties, including taste and texture of milk. The modular fat-filled milk powder with ultrafiltered fresh milk was compared to the reference fat-filled milk powder. The modular fat-filled milk powder prepared with ultrafiltered fresh milk retains acceptable and even equivalent sensory properties compared to the reference fat-filled milk powder.

TABLE 3

| | Amount in the final |
|---|---|
| | powder |
| Ingredients | (% db) |
| Water evaporation | 0.58 |
| Crystalline sucrose | 5.77 |
| Maltodextrin | 12.90 |
| Palm fat | 6.20 |
| Lecithin | 0.32 |
| Vitamins, Minerals, Salts | 3.65 |
| Flavours | 0.47 |
| Milk fat anhydrous (coming | 14.46 |
| from the ultrafiltered fresh | |
| milk) | |
| Milk solid non fat (coming | 5.13 |
| from the ultrafiltered fresh | |
| milk) | |
| Skimmed milk powder | — |
| Crystalline Lactose | 33.7 |
| Milk fat anhydrous | — |
| Milk protein concentrate | 17.36 |

### Example 6: Analytical Characterisation

Water activity was measured with the AquaLab 4TE Decagon (Decagon Devices Inc., US). The measurement is based on the detection of dew on the mirror when the sample and the headspace are in equilibrium in terms of relative humidity and temperature. The measurements are performed at 25° C. (+0.1° C.) for all samples. The instrument has a measuring interval of 5 minutes approximately, recording the value. The water activity is determined in duplicate with a precision of +0.007.

Moisture content was determined using the oven method at 102° C. during 2 h with a sample mass of around 2 g.

Glass transition temperature (T_{g}) is measured by Differential Scanning calorimetry (TA Instrument Q2000). A double scan procedure was used to erase the relaxation enthalpy and get a more precise determination of the glass transition. For this, every sample, weighing 10 to 30 mg, is scanned with a heating rate of 5° C./min starting from 25 up to approximately 100° C. The system is then cooled with 20° C./min before running the second scan. The glass transition temperature was determined from the second scan, defined by the onset of the steep change in heating capacity. Based on previous experience, the glass transition is determined with a precision of ±3° C.

Sorption isotherms were built based on a rapid method. For this, samples are stored in desiccators (i.e. one for partial drying and one for partial humidification) during a short period of time typically around 48 h. This allows to pre-equilibrate the samples at different water activities. Minimum five different points (water activities/water contents/T_{g}) are required for a robust sorption isotherm determination. Every sample is then subjected to a 2 h thermal treatment at T_{g}+5° C. to overcome moisture gradients within the product and obtain the so-called equilibrated water activity aw.

Moisture sorption kinetics experiment were conducted in the water sorption equipment SPS (proUmid, Ulm). The same volume of sample was placed in the aluminum pans and tared. The samples were then equilibrated at 25° C., 20% relative humidity until reaching an equilibrium (reached after 100 hours). Subsequently the relative humidity was increased from 20 to 70% in steps of 5% r.H. every 24 hours. 24 hours were used allowing for an equilibration of the sample and potential crystallization to occur. Moisture is absorbed by the different samples. The resulting weight gain relates to the quantity of moisture absorbed by the sample.

### Example 7: Physical Stability Evaluation

### 6.1 Reference and Modular Whole Milk Powder

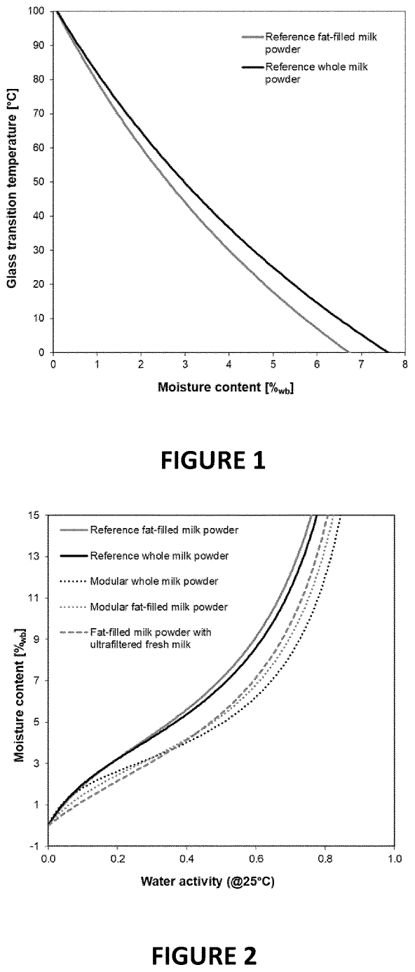

Physical stability of the reference and modular whole milk of respectively example 1 and 2 was evaluated based on sorption isotherms. The sorption isotherms were measured as disclosed in example 6 and illustrated based on glass transition temperature (T_{g}) and moisture content (FIG. 1) or based on moisture content and water activity (FIG. 2). The T_{g}, moisture content and water activity were measured as disclosed in example 6.

The results are shown in FIGS. 1 and 2.

When comparing the sorption isotherms of reference and the modular whole milk, it can be observed that the removal of the lactose from the wet mix and dry addition of lactose in crystalline form only in the powder after drying considerably decreases the hygro-capacity of the whole milk powder (higher water activities are expected at equivalent moisture content) (cf. FIGS. 1 and 2). It can be concluded that the removal of the amorphous lactose from the milk powder so that it comprises only crystalline lactose yields a powder that does not exhibit a glass transition temperature anymore and is hence more robust against caking over shelf-life (cf. FIG. 1).

### 6.2 Fat-Filled Milk Powders

Physical stability of the reference, modular fat-filled milk powders and modular fat-filled milk powder prepared with ultrafiltered fresh milk of respectively example 3, 4 and 5 was evaluated based on sorption isotherms. The sorption isotherms were measured as disclosed in example 6 and illustrated based on T_{g} and moisture content (FIG. 1) or based on moisture content and water activity (FIG. 2). The T_{g}, moisture content and water activity were measured as disclosed in example 6.

The results are shown in FIGS. 1 and 2.

Only the reference fat-filled milk powder showed a glass transition temperature (T_{g}) while for the modular fat-filled milk powder without amorphous lactose and comprising only crystalline lactose, no T_{g} could be determined (FIG. 1). This indicated that the modular fat-filled milk powder comprising only crystalline lactose should be more resistant to caking. Moreover, removal of the amorphous lactose and dry addition of crystalline lactose impacted the hygro-capacity of the samples (cf. FIGS. 1 and 2). The modular fat-filled milk powder which is free of amorphous lactose and comprises only crystalline lactose demonstrated a decreased hygro-capacity compared to the reference fat-filled milk powder comprising amorphous lactose (cf. FIG. 2). This means that lower moisture content values are reached at equivalent water activity for the modular fat-filled milk powder versus reference fat-filled milk powder. The conclusions provided for the modular fat-filled milk powder also apply to the modular fat-filled milk powder with ultrafiltered fresh milk. In particular, the modular fat-filled milk powder with ultrafiltered fresh milk exhibits enhanced physical stability, in particular enhanced hygro-stability (cf. FIGS. 1 and 2).

### Example 8: Moisture Sorption Kinetics

The moisture sorption kinetics of the reference and modular fat-filled milk powder of respectively examples 3 and 4 was evaluated according to the moisture sorption kinetics experiment method of example 6.

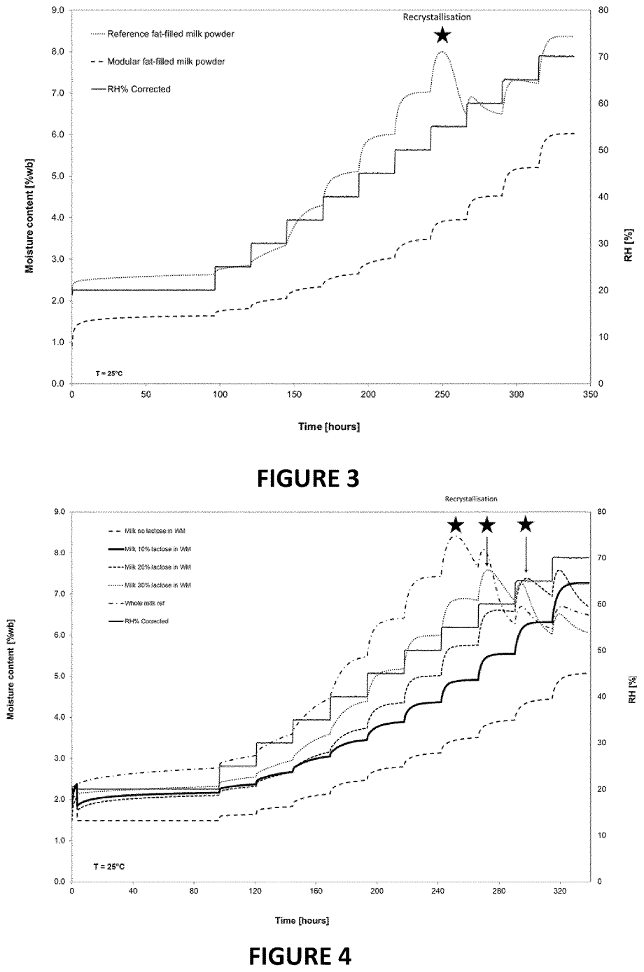

The moisture sorption kinetics of the reference and modular fat-filled milk powder of examples 3 and 4 respectively with increasing relative humidity are illustrated in FIG. 3.

The reference fat-filled milk absorbed much more moisture than to the modular fat-filled milk that comprises mostly crystalline lactose. Hence, the modular fat-filled milk allows a shelf-life increase before reaching critical water activities. Additionally, the reference fat-filled milk powder demonstrated a peak at a relative humidity of 55% indicating the recrystallisation of the lactose causing stability and reconstitution issues in the milk powders (cf. stars in FIG. 3). Hence moving the lactose from the amorphous to the crystalline state allows to create powders with increased stability here shown by a decrease in hygro-capacity and hence decrease in moisture sorption kinetics.

### Example 9: Amount of Amorphous Lactose Tolerated

The maximum amount of amorphous lactose tolerated in the milk powder that still allow acceptable physical stability and moisture pick-up over shelf-life was investigated.

To do this assessment, modular whole milk powders with different amounts of amorphous and crystalline lactose were produced as well as a reference with mostly all the lactose in the amorphous state.

To do so, milk fat anhydrous, milk protein concentrate, and lactose were mixed at 60° C. with water until there are no lumps anymore to obtain a homogenous wet mix having a total solids content of 40 wt %. The quantity (as dry basis) of different ingredients in the wet mix is given in table 4 (corresponds to the amount of ingredient in final powder before dry mixing with crystalline lactose). Five different % of lactose in the amorphous state were used ranging from 0-100% amorphous lactose (0, 25, 50, 75 and 100% amorphous lactose respective to the total lactose content which corresponds to about 0, 10, 20, 30, 39.4% db of amorphous lactose in the final powder). The wet mix of the modular whole milk powder with about 0, 10 and 20% db amorphous lactose were further diluted in water to a total solids content of 30% TS to adjust the viscosity. The different wet mixes were homogenized 140 bars and at 60° C., pasteurized at 83° C. for 4 seconds and then spray dried to obtain modular whole milk powders with different amount of amorphous lactose.

The spray dried modular whole milk powders were subsequently remixed with the required amount of crystalline lactose (see Table 5) to reach the same overall lactose concentration of about 39.4% db.

The whole milk reference was prepared as provided in example 1.

TABLE 4

| | | Modular | | | |
|---|---|---|---|---|---|
| | Whole milk | milk | | | |
| | reference | reference | 10% lactose | 20% lactose | 30% lactose |
| | (100% of | (0% of total | (25% of total | (50% of total | (75% of total |
| | total lactose | lactose % | lactose % | lactose % | lactose % |
| | % db) | db) | db) | db) | db) |
| Milk protein | 32.3 | 53.3 | 45.9 | 40.1 | 35.6 |
| concentrate | | | | | |
| Milk fat | 28.3 | 46.7 | 40.0 | 35.1 | 31.3 |
| Lactose in | 39.4 | 0.00 | 14.1 | 24.8 | 33.1 |
| wet mix | | | | | |
| (i.e. | | | | | |
| amorphous | | | | | |
| lactose) | | | | | |

TABLE 5

| | Modular | 10% lactose | 20% lactose | 30% lactose |
|---|---|---|---|---|
| | milk (% db) | (% db) | (% db) | (% db) |
| Quantity of modular | 60.6 | 70.5 | 80.3 | 90.2 |
| whole milk powders | | | | |
| with different amount | | | | |
| of amorphous lactose | | | | |
| dry mixed with | | | | |
| crystalline lactose | | | | |
| Quantity of crystalline | 39.4 | 29.5 | 19.7 | 9.8 |
| lactose dry mixed with | | | | |
| the modular whole | | | | |
| milk powders | | | | |

The moisture sorption kinetics of the different modular whole milk powders was evaluated according to the moisture sorption kinetics experiment method of example 6.

The results are illustrated in FIGS. 4 and 5, where FIG. 5 zooms into the relevant section of FIG. 4 to better illustrate the differences.

Increasing the amount of amorphous lactose resulted in higher moisture contents at equivalent water activity. Moreover, in the milk powders with about 20, 30% and 40% db amorphous lactose, recrystallisation of the lactose occurred (cf. stars in FIGS. 4 and 5). This recrystallisation is undesirable as it negatively impacts the properties of the powder, in particular the reconstitution properties of the powder. In the sample with about 10% db amorphous lactose, no recrystallisation was observed up to a relative humidity of 70%.

Consequently, about 10% db of amorphous lactose seems to be tolerated based on the physical stability and powder with acceptable stability, in particular hygro-stability is obtained.

1. A method of making a food powder, the said method comprising:
a. Providing a liquid food composition, wherein the liquid food composition comprises at most 20 wt % of mono- and/or di-saccharides by dry weight of the liquid food composition and further comprises at least one component different from mono- and/or di-saccharides,
b. drying the liquid food composition to obtain a first food powder,
c. adding crystalline mono- and/or di-saccharides to the first food powder to form a second food powder, wherein at most 30% of the mono- and/or di-saccharides of the second food powder are amorphous and the remainder of the mono- and/or di-saccharides of the second food powder are crystalline.

2. The method according to claim 1, wherein the liquid food composition is free from mono- and/or di-saccharides.

3. The method according to claim 1, wherein the second food powder is free from amorphous mono- and/or di-saccharides.

4. The method according to claim 1, wherein the total mono and/or di-saccharides content of the second food powder is 10 to 80 wt. %.

5. The method according to claim 1, wherein the at least one component different from mono- and/or di-saccharides of the liquid food composition is selected from the group consisting of proteins, fat, emulsifier, salts and a mixture thereof.

6. The method according to claim 5, wherein the proteins of the liquid food composition are selected from the group consisting of dairy proteins, plant proteins and a mixture thereof.

7. The method according to claim 5, wherein the fat is selected from the group consisting of vegetable fat, milk fat and a mixture thereof.

8. The method according to claim 1, wherein the second food powder is a dairy-based food powder or a plant-based analogue thereof.

9. The method according to claim 1, wherein the liquid food composition of step a) is made by a process comprising dispersing at least one protein ingredient into an aqueous liquid to form the liquid food composition.

10. The method according to claim 1, wherein the liquid food composition of step a) is made by a process comprising:
providing a liquid food composition comprising mono- and/or di-saccharides; and
removing part or all mono-saccharides of the liquid food composition via filtration.

11. The method according to claim 1, wherein the crystalline mono- and/or di-saccharides are added in step c) by dry mixing or by fluid bed agglomeration.

12. The method according to claim 1, wherein the step b) and the step c) are simultaneous, and wherein the crystalline mono- and/or di-saccharides are directly added into a dryer while the liquid food composition is dried into the dryer.

13. A food powder which comprises at least one component different from mono- and disaccharides and which further comprises mono- and/or di-saccharides, wherein at most 25 wt % of the mono- and/or di-saccharides of the food powder are amorphous and the remainder of the mono- and/or di-saccharides of the food powder are crystalline.

14. The food powder according to claim 13, wherein the at least one component different from mono- and disaccharides is selected from the list consisting of proteins, fat, emulsifier, salts and a mixture thereof.

15. The food powder according to claim 13, which is a spray-dried food powder.

16. A food powder which is obtained by a method according to claim 1.

17. The method according to claim 1, wherein at most 10% of the mono- and/or di-saccharides of the second food powder are amorphous.

18. The method according to claim 1, wherein the total mono and/or di-saccharides content of the second food powder is 20 to 60 wt. %.

19. The method according to claim 1, wherein the liquid food composition of step a) is made by a process comprising (i) dispersing least one protein ingredient into an aqueous liquid to form the liquid food composition and (ii) at least one step selected from the group consisting of mixing the liquid food composition with at least one fat and/or at least one emulsifier; heat-treating the liquid food composition; and homogenizing the liquid food composition.

20. The method according to claim 1 wherein the liquid food composition of step a) is made by a process comprising (i) providing a liquid food composition comprising mono- and/or di-saccharides; (ii) removing part or all mono-saccharides of the liquid food composition via filtration; and (iii) at least one step selected from the group consisting of heat-treating the liquid food composition and homogenizing the liquid food composition.
